(19) United States
(12) Patent Application Publication
(10) Pub. No.: US 2009/0231080 A1
(43) Pub. Date: Sep. 17, 2009

(54) Coil body for an electric oil and method for producing an electronic element provided with said coil body

(75) Inventors: Wolfgang Ebert, Trostberg (DE); Jürgen Klier, Traunreut (DE); Bernhard Orben, Trostberg (DE)

Correspondence Address: OSRAM SYLVANIA INC, 100 ENDICOTT STREET, DANVERS, MA, 01923, US

(73) Assignee: Patent-Treuahand Gesellschaft Fur Elektrische Gluhlampen MBH, Munchen (DE)

(21) Appl. No.: 11/989,294

(22) PCT Filed: Jul. 27, 2006
(86) PCT No.: PCT/EP2006/007468

§ 371 Date: Jan. 24, 2008

(30) Foreign Application Priority Data
Jul. 29, 2005 (DE) 202005011962.8

(51) Int. Cl. H01F 27/30; H01F 41/00

(52) U.S. Cl. 336/198; 336/208; 29/606

(57) ABSTRACT

The invention relates to a coil former (1) for an electrical coil having a hollow central region for accommodating a subregion of a coil core (2) in the interior (11a) of the hollow central region and for applying at least one winding (3) to the outer side (11b) of the central region, movable flaps (12a, 12b) being arranged at side regions of the coil former (1) and being designed such that, in the closed state, they are arranged as electrical insulation between the winding (3) and adjacently arranged outer limbs (21) of the coil core (2). The invention also relates to an electronic component having such a coil former (1) and to a method for producing such an electronic component.

### TECHNICAL FIELD

The present invention relates to a coil former for an electrical coil, the coil former having a hollow central region for accommodating a subregion of a coil core, and it being possible for a winding to be applied to an outer side of the central region. Furthermore, the invention relates to an electronic component which comprises such a coil former. In addition, the invention also relates to a method for producing an electronic component having such a coil former.

### PRIOR ART

A magnetic component known from the prior art is illustrated schematically in FIG. 1. This component has a coil former 1, which is at least partially surrounded by a coil core 2. The coil former 1 in this case also comprises a central region, which cannot be seen in the illustration in FIG. 1, and which has a hollow design and is arranged for accommodating a subregion of the coil core 2. The coil core 2 generally consists of ferrite. As can be seen, a winding 3, which can be wound, for example, from copper wire, is wound on on the outer side of the central region of the coil former 1. The winding 3 is in this case insulated from that subregion of the coil core 2, which is arranged in the interior of the central region, by the central region of the coil former 1.

As can further be seen in FIG. 1, the coil core 2 has outer limbs 21 which are arranged adjacent to the winding 3. The winding 3 is separated from these outer limbs 21 merely by an air gap. However, in order for it to function properly, sufficient insulation of the winding 3 with respect to the coil core 2, in particular towards the outer limbs 21 of the coil core 2, needs to be provided.

The value is established by the voltage load of the respective application (for example 2000 Vrms). The insulation from that subregion of the coil core 2 which is arranged in the interior of the central region of the coil former 1 is ensured by the enveloping coil former material. However, only this air gap exists with respect to the two outer limbs 21. The air gap to be maintained is dependent on the respective voltage load and the manufacturing requirements. This means that the area in which the winding 3 is arranged can only be used to a limited extent. If, owing to a design which is optimized in terms of losses, the required distance between the winding 3 and the outer limbs 21 cannot be maintained, additional insulation in the form of a so-called horseshoe tape needs to be introduced, as is shown in FIG. 2. However, this results in considerable additional costs and in a considerably more complex design. Such an arrangement of a horseshoe tape is also required in the case of relatively high dielectric strengths, in the case of which the required air gap cannot be realized.

### DESCRIPTION OF THE INVENTION

The present invention is therefore based on the object of providing a coil former for an electrical coil, with which coil former it is possible to achieve improved insulation of the winding of the electrical coil. Furthermore, it is one object of the invention to provide an electronic component having such a coil former, in the case of which it is likewise possible to achieve improved insulation between a winding of the electrical coil and a coil core. In addition, it is one object of the present invention to provide a method for producing such an electronic component having a coil former according to the invention.

These objects are achieved by a coil former having the features of patent claim 1, by an electronic component having the features of patent claim 9 and by a method for producing an electronic component having the features of patent claim 12.

A coil former according to the invention for an electrical coil comprises a central region, which has a hollow inner structure for accommodating a subregion of a coil core. The central region of the coil former is designed such that it is possible to apply a winding of the electrical coil to its outer side. One important concept of the invention consists in the fact that movable flaps are arranged at side regions of the coil former and are designed such that, in the closed state, the movable flaps are arranged as electrical insulation between the winding and adjacently arranged outer limbs of the coil core. By attaching such flaps, which can be moved in relation to the rest of the coil former, it is possible to achieve a situation in which, on the one hand, it is possible to apply a winding in a simple manner and, on the other hand, it is possible to achieve effective electrical insulation between a coil core and the winding. Owing to the fact that the flaps can move, it is thus also possible to achieve a situation in which low-complexity and therefore also cost-effective production both of the coil former itself and of an electrical coil can be ensured.

In an advantageous manner, the movable flaps are arranged at opposite side regions. This makes it possible to achieve a situation in which, in particular in the critical regions in which the winding is arranged adjacent to the outer limbs of the coil core, reliable and safe insulation can be ensured.

The movable flaps are preferably in the form of plates. This allows for sufficient insulation essentially over the entire length of a side region of the coil former. Furthermore, it is also possible as a result for relatively space-saving insulation to be formed.

In a particularly advantageous manner, the movable flaps are integrated in the coil former. An integral production of the movable flaps with the remaining part of the coil former ensures a relatively simple and low-complexity production process. Furthermore, no further manufacturing and assembly steps are required in order to fix the movable flaps to the coil former.

The movable flaps are advantageously each connected to the side regions of the coil former via a hinge apparatus. The hinge apparatuses are preferably in the form of film hinges. Each of the hinge apparatuses is advantageously curved, in particular arcuate. The curvature in this case may be both concave and convex in a plan view of the coil former. As a result, a movement mechanism for opening and closing the movable flaps can be provided, in the case of which the open or the closed end position of the movable flaps can be retained independently in a stable manner.

For example, the open state of the movable flaps can therefore be held securely when the winding is applied. This makes it possible to prevent the operation involving the application of the winding to the coil former from being impaired by an unintentional movement of the flaps when the coil former is rotated. Furthermore, it is possible to achieve a situation in which the flaps retain the closed state independently if the flaps are closed.

The curved formation of a hinge apparatus is preferably designed such that, starting from an open state of the flaps, said flaps are closed by such a force effect on the flaps, which force effect increases, as the closure operation progresses, up to a certain point (rising force curve) and, once this point has been exceeded, preferably decreases again for further closing of the flaps up to the end state (falling force curve). The same applies to an opening operation of the flaps. The force curve can be adjusted by the curvature of the hinge apparatuses. In a corresponding manner, the position of the point during an opening or closing operation of the flaps at which the maximum force effect is required for further moving the flaps can also be influenced by the curvature. As a result, it is also possible to obtain haptic feedback on the state of the opening or closing operation which has already been reached.

In the initial state, the movable flaps are arranged on the coil former such that they are provided virtually in the open state. This makes it possible for the winding to be attached without the movable flaps first needing to be swung open or actuated. The regions on the outer side of the central region of the coil former are freely accessible in the initial state.

One further aspect of the invention relates to an electronic component which has a coil former according to the invention or an advantageous refinement thereof. The coil former furthermore comprises a winding arranged around the coil former and a coil core, the coil core comprising two outer limbs which at least partially engage around the coil former. In addition to these essential features of the electronic component, said electronic component may also have further elements and further refinements.

The movable flaps are preferably closed once the winding has been attached to the coil former and before the coil core is attached. This makes it possible to position the various elements of the electronic component in a relatively simple manner.

The coil core of the electronic component, in the assembled state of this electronic component, is arranged such that the closed state of the movable flaps can be effected by the coil core, in particular the outer limbs of the coil core. This means that the arrangement of the coil core and the coil former is such that the outer limbs engage around the side region of the coil former such that the movable flaps can be held in the closed state. Provision may also be made for it to be possible for the closed state of the flaps to be held, as an alternative or in addition, by a latching device.

In a method according to the invention for producing an electronic component, a coil former according to the invention or an advantageous refinement thereof is arranged and installed in the electronic component. A coil core of the electronic component comprises at least two outer limbs, which are spaced apart from a winding which is arranged at a central region of the coil former. The outer limbs are positioned such that they at least partially engage around the coil former. One important concept of the method according to the invention consists in the fact that movable flaps are attached to the coil former, are closed once the winding has been applied to the coil former and, in the closed state, are positioned between the winding and the outer limbs of the coil core, as a result of which insulation is produced between the winding and the outer limbs of the coil core.

In an advantageous manner, the movable flaps are integrally extruded at opposite sides of the coil former. Provision may be made for the entire coil former to be produced integrally by means of an injection molding process.

The coil former is preferably fitted once the movable flaps have been closed, in particular such that the closed state is held by the outer limbs of the coil core. This makes it possible to achieve a situation in which the positions of the elements in relation to one another are securely retained and the closed state of the movable flaps is maintained in a reliable manner. This also makes it possible to achieve continuously reliable insulation between the winding and the coil core, in particular the outer limbs of the coil core.

### BRIEF DESCRIPTION OF THE DRAWINGS

The invention will be explained in more detail below with reference to schematic drawings, in which:

FIG. 1 shows a front view of an electronic component known from the prior art;

FIG. 2 shows a perspective illustration of a further electronic component known from the prior art;

FIG. 3 shows a perspective illustration of a coil former according to the invention;

FIG. 4 shows a further perspective illustration of a coil former according to the invention; and

FIG. 5 shows a detail drawing of a preferred embodiment.

### PREFERRED EMBODIMENT OF THE INVENTION

Identical or functionally identical elements in the figures are provided with the same reference symbols.

A coil former 1 according to the invention is shown in a schematic illustration in FIG. 3. In terms of its elements which are essential to the invention, the coil former 1 comprises a central region which has a hollow interior 11a. A subregion of a coil core 2 (not illustrated) may be positioned in this hollow interior 11a. The central region has an outer side 11b, to which a winding 3 (not illustrated) can be attached so as to completely pass around the central region of the coil former 1. As can be seen, protruding positioning elements 11c are arranged on these outer sides 11b. As a result, the winding 3 arranged on the outer sides 11b can be held stably in position. As essential elements of the coil former 1 according to the invention, movable flaps 12a and 12b are arranged on the coil former 1. As can be seen, in the exemplary embodiment shown in FIG. 3, these two flaps 12a and 12b are arranged on opposite longitudinal sides of the essentially square coil former 1. In the exemplary embodiment, these two flaps 12a and 12b are integrally extruded at the upper edge of a positioning element 11c, the movable flaps 12a and 12b each being arranged on the positioning element 11c via a hinge apparatus. In the exemplary embodiment, the hinge apparatuses are in the form of film hinges, only the film hinge 121 being visible in FIG. 3. As can be seen in FIG. 3, the film hinge 121 is designed to have a thickness which, in comparison to the thickness of the movable flap 12b and to the region directly adjacent to the positioning element 11c, has a tapered design. In the exemplary embodiment, the film hinge 121 has a linear design. This means that the film hinge 121 is straight over the entire length of the movable flap 121 and is arranged essentially at the lower edge of the side region of the positioning element 11c. In a similar manner, a film hinge is formed and arranged in the region of the movable flap 12a.

However, provision may also be made for the film hinge 121 to be arcuate and to have, for example, a concave design as regards a plan view illustration of the coil former 1 illustrated in FIG. 3. In this case, provision may be made for the film hinge 121 to be arranged at the opposite end regions of the longitudinal extent of the film hinge 121 at the lower edge of the positioning element 11c and to arch such that it is arranged in the center of its longitudinal extent at the upper edge of the positioning element 11c. Given such a curvature of the film hinge 121, the point of maximum force effect for further actuation of the movable flap 12b can preferably be at a pivoting angle covered of approximately 90° starting from the initial position of the movable flap 12b shown in FIG. 3. In the initial position, the movable flap 12b may have, for example, a tilt of approximately 30° with respect to the vertical. In a corresponding manner, the shaped-out section of the film hinge may be in the region of the flap 12a.

As can be seen from the illustration in FIG. 3, in this initial state of the coil former 1, these two flaps 12a and 12b are oriented obliquely upwards, with the result that the intermediate regions between these positioning elements 11c are freely accessible. As a result, it is possible for a winding (not illustrated) to be attached easily and with little complexity to the outer sides 11b of the central region.

Provision may also be made for each of the two flaps 12a and 12b to be of two-part design and for the two parts to be arranged on an upper and a lower positioning element 11c, respectively, on one side of the coil former such that they are moved towards one another in order to be closed and are preferably arranged such that they overlap when a closed state has been reached.

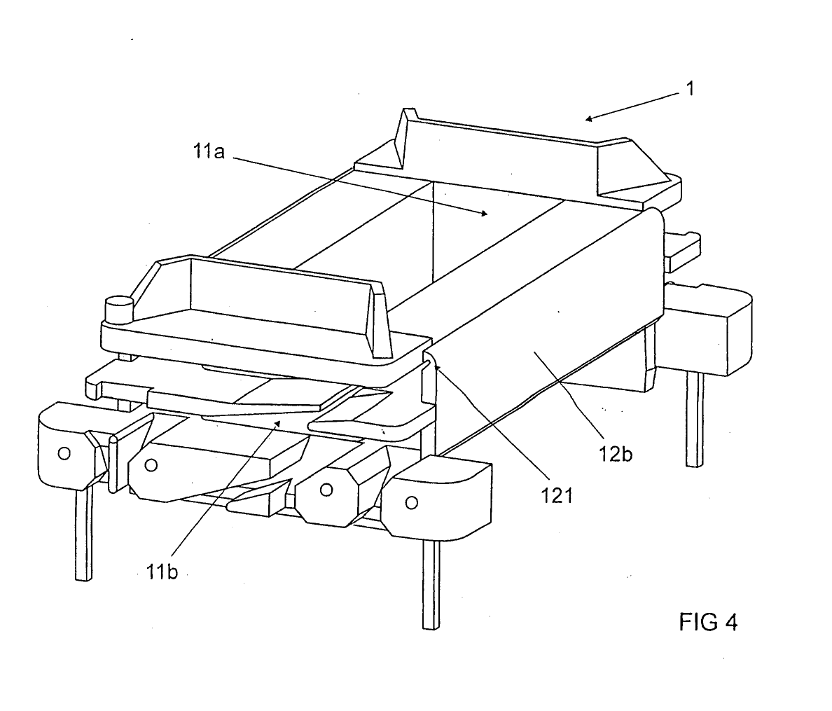

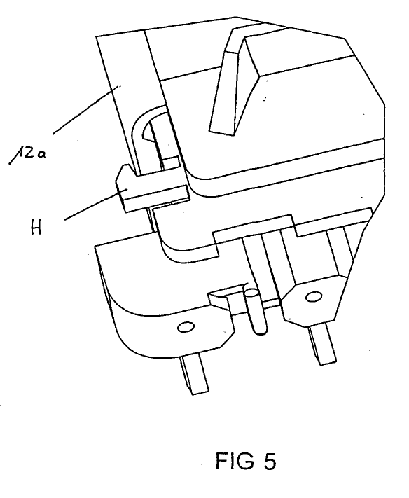

FIG. 4 shows a further perspective illustration of a coil former 1 according to the invention in a second state. In this case, it can be seen in FIG. 4 that the two flaps 12a and 12b are pivoted downwards and show a closed state. The winding, which is arranged on the outer side 11b of the central region and is not illustrated in FIG. 4, is as a result covered by the plate-shaped, movable flaps 12a and 12b at these side regions. The movable flaps 12a and 12b as a result form space-saving insulation for the winding with respect to a coil core (not illustrated).

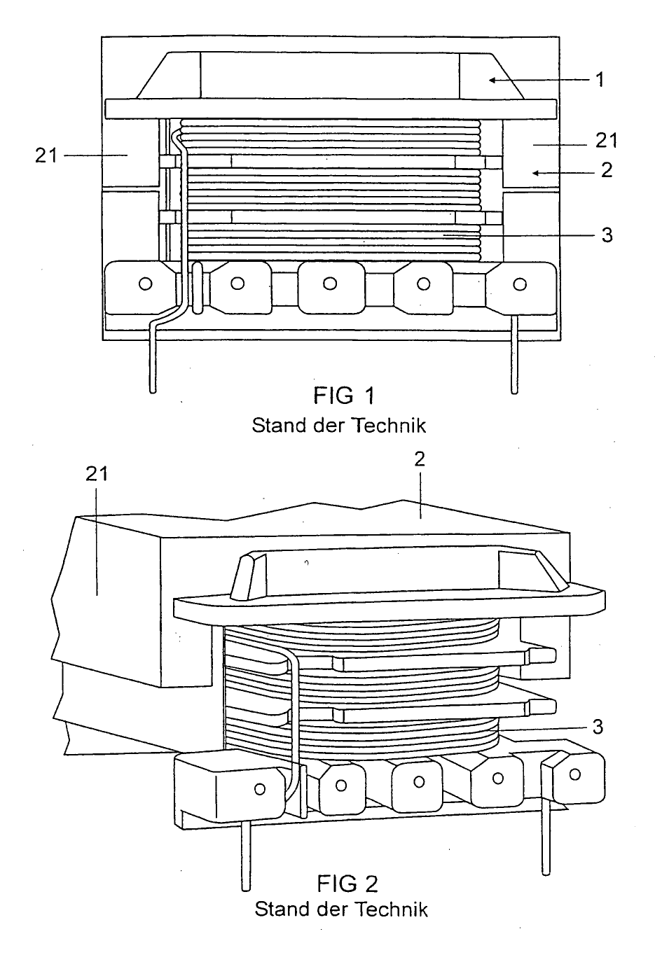

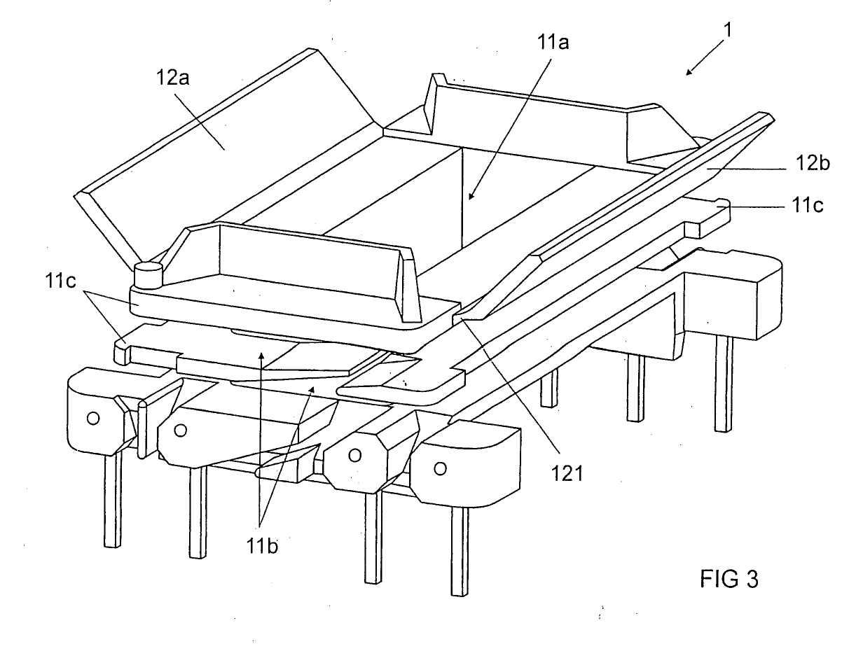

The coil core 2 (see FIGS. 1 and 2) can subsequently be attached to the coil former 1 so as to correspond to the arrangement shown in FIG. 1 and FIG. 2. In this case, a central subregion of the coil core 2 engages in the interior 11a of the central region of the coil former 1. Furthermore, the outer limbs 21 of the coil core 2 engage around the coil former 1 at the side regions at which the movable flaps 12a and 12b are also arranged. The coil core 2 and the coil former 1 are in this case shaped such that the outer limbs 21, in the exemplary embodiment, bear against the movable flaps 12a and 12b and therefore engage around the coil former 1 such that the movable flaps 12a and 12b are held in the closed state by the outer limbs 21. In such an assembled refinement of an electronic component with such a coil former 1 and with a winding 3 and a coil core 2, the movable flaps 12a and 12b are then used as effective insulation between this winding 3 and the coil core 2, in particular the outer limbs 21. The area in which the winding 3 is arranged can therefore be completely utilized and have an optimum design in terms of losses. The existing problem in the prior art, which envisages either an air gap between the winding 3 and the coil core 2 or the attachment of a so-called horseshoe tape, can be prevented by the invention. The invention can be used for all coil core shapes and all coil core materials.

FIG. 5 shows a detail drawing of a preferred embodiment. In the embodiment of FIG. 4 the movable flaps 12a and 12b are held in the closed state by the coil core. In the case of insufficient dimensional accuracy of the coil core this may lead to the winding space not being entirely covered by the movable flaps 12a and 12b and to a gap resulting. This is prevented by the embodiment according to FIG. 5. A hook H snaps over the movable flaps 12a and 12b when the coil core is pushed on and presses the movable flaps 12a and 12b against the winding space. This ensures that the winding space is entirely covered laterally by the movable flaps 12a and 12b and no gap results.

1. A coil former for an electrical coil having a hollow central region for accommodating a subregion of a coil core (2) in the interior (11a) of the hollow central region and for applying at least one winding (3) to an outer side (11b) of the central region,
characterized in that movable flaps (12a, 12b) are arranged at side regions of the coil former (1) and are designed such that, in the closed state, they are arranged as electrical insulation between the winding (3) and adjacently arranged outer limbs (21) of the coil core (2).

2. The coil former as claimed in claim 1, characterized in that the movable flaps (12a, 12b) are arranged at opposite side regions.

3. The coil former as claimed in claim 1, characterized in that the movable flaps (12a, 12b) are in the form of plates.

4. The coil former as claimed in claim 1, characterized in that the movable flaps (12a, 12b) are integrated in the coil former (1).

5. The coil former as claimed in claim 1, characterized in that the movable flaps (12a, 12b) are each connected to the side regions of the coil former (1) via a hinge apparatus, in particular a film hinge (121).

6. The coil former as claimed in claim 5, characterized in that each of the hinge apparatuses has a curved, in particular arcuate profile.

7. The coil former as claimed in claim 5, characterized in that each of the movable flaps (12a, 12b) is held stably in position in the closed and/or open end state by the associated hinge apparatus, in particular by a curved hinge apparatus.

8. The coil former as claimed in claim 1, characterized in that the movable flaps (12a, 12b) are opened before the winding (3) is attached to the coil former (1).

9. An electronic component having a coil former as claimed in claim 1 and having at least one winding (3) and a coil core (2), the coil core (2) having two outer limbs (21) which at least partially engage around the coil former (1).

10. The electronic component as claimed in claim 9, characterized in that the movable flaps (12a, 12b) are closed once the winding (3) has been attached to the coil former (1) and before the coil core (2) is attached.

11. The electronic component as claimed in claim 10, characterized in that the coil core (2), in the assembled state of the electronic component, is arranged such that the closed state of the movable flaps (12a, 12b) can be effected by the coil core (2), in particular the outer limbs (21) of the coil core (2).

12. A method for producing an electronic component having a coil former (1) and a coil core (2), the coil core (2) having at least two outer limbs (21) which are arranged such that they are spaced apart from the winding (3) and at least partially engage around the coil former (1), characterized in that movable flaps (12a, 12b) are attached to the coil former (1), are closed once the winding (3) has been applied to the coil former (1) and, in the closed state, are positioned as insulation between the winding (3) and the outer limbs (21) of the coil core (2).

13. The method as claimed in claim 12, characterized in that the movable flaps (12a, 12b) are integrally extruded at opposite side regions of the coil former (1).

14. The method as claimed in claim 12, characterized in that the coil core (2) is fitted once the movable flaps (12a, 12b) have been closed, in particular such that the closed state is held by the outer limbs (21) of the coil core (2).

15. The method as claimed in claim 12, characterized in that the movable flaps (12a, 12b) are each connected to the side regions of the coil former (1) via hinge apparatuses, in particular film hinges (121), the hinge apparatuses being curved, in particular arcuate.

16. The method as claimed in claim 15, characterized in that each of the movable flaps (12a, 12b) is held stably in position in the closed and/or open end state by the associated hinge apparatus, in particular by a curved hinge apparatus.

17. The method as claimed in claim 13, characterized in that the coil core (2) is fitted once the movable flaps (12a, 12b) have been closed, in particular such that the closed state is held by the outer limbs (21) of the coil core (2).

18. The method as claimed in claim 13, characterized in that the movable flaps (12a, 12b) are each connected to the side regions of the coil former (1) via hinge apparatuses, in particular film hinges (121), the hinge apparatuses being curved, in particular arcuate.

19. The coil former as claimed in claim 2, characterized in that the movable flaps (12a, 12b) are in the form of plates.

20. The coil former as claimed in claim 6, characterized in that each of the movable flaps (12a, 12b) is held stably in position in the closed and/or open end state by the associated hinge apparatus, in particular by a curved hinge apparatus.
